(19) United States
(12) Patent Application Publication
(10) Pub. No.: US 2009/0122542 A1
(43) Pub. Date: May 14, 2009

(54) AUXILIARY ILLUMINATION DEVICE

(75) Inventors: FU-YEN TSENG, Tu-Cheng (TW); CHIA-WEN LIAO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/125,888

(22) Filed: May 22, 2008

(30) Foreign Application Priority Data
Nov. 9, 2007 (CN) 200710202438.8

(51) Int. Cl. F21V 11/00

(52) U.S. Cl. 362/236

(57) ABSTRACT

An auxiliary illumination device includes a circuit board, a lamp cover including a high illumination light cover mounted on the circuit board and a low illumination light cover mounted on the circuit board, and at least two lamps electrically connected to the circuit board and disposed inside the high illumination light cover and the low illumination light cover respectively.

### TECHNICAL FIELD

The present invention relates to an auxiliary illumination device, and more particularly, to an auxiliary illumination device for use in an image-capturing device to provide auxiliary light for capturing an image with excellence luminance.

### BACKGROUND

Generally, a flash lamp or an auxiliary illumination device is employed in order to capture a quality image with a camera or other similar device in an environment with dim light. However, the flash lamp can't provide a continuous light due to interruption of charge and discharge. For solving the above-mentioned problem, the auxiliary illumination device is employed to overcome disadvantages of the flash lamp. For example, an auxiliary lamp lacks luminous intensity. In addition, the auxiliary illumination device is short of effective far-reaching illumination.

Therefore, there is a need to design an auxiliary illumination device for overcoming the above-mentioned problems.

### SUMMARY

According to the claimed invention, an auxiliary illumination device includes a circuit board, a lamp cover including a high illumination light cover mounted on the circuit board and a low illumination light cover mounted on the circuit board, and at least two lamps electrically connected to the circuit board and disposed inside the high illumination light cover and the low illumination light cover respectively.

Those and other advantages and novel features will be more readily apparent from the following detailed description set forth below taken in conjunction with the accompanying drawings.

### BRIEF DESCRIPTION OF THE DRAWINGS

FIG. 1 is a schematic drawing of an auxiliary illumination device according to an exemplary embodiment of the present invention; and

FIG. 2 is a schematic drawing of an illumination range of the auxiliary illumination device shown in FIG. 1.

### DETAILED DESCRIPTION OF THE PREFERRED EMBODIMENTS

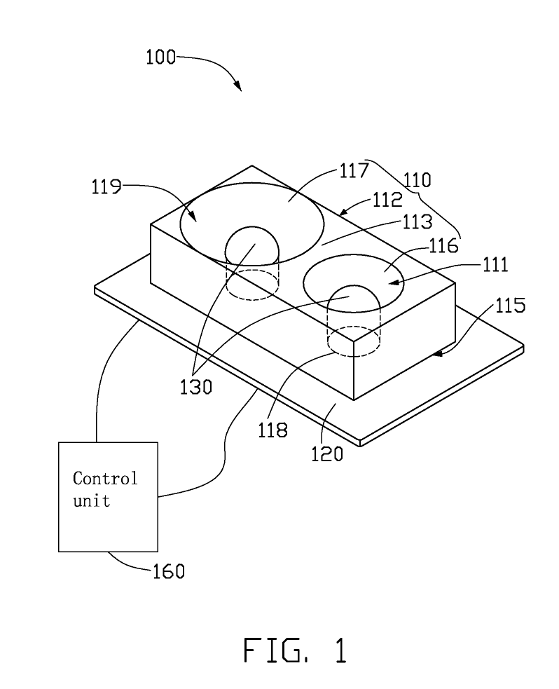

Referring to FIG. 1, an auxiliary illumination device 100 according to an exemplary embodiment of the present invention includes a lamp cover 110, a circuit board 120 connected to the lamp cover 110, and at least two lamps 130 disposed inside the lamp cover 110 and electrically connected to the circuit board 120. The auxiliary illumination device 100 be configured for use in any device which might benefit from auxiliary illumination, such as a device with an image-capturing function, e.g. a camera, a mobile phone etc.

The lamp cover 110 includes a basic body 112 having an upper surface 113 and an lower surface 115 opposite to the upper surface 113. A first cavity 116 and a second cavity 117 are adjacently spaced apart on the upper surface 113 of the basic body 112. The bottom surfaces of the first cavity 116 and the second cavity 117 are concave. The concave surfaces can be spherical surfaces or aspherical surfaces. The lowest points of the two concave surfaces are located on a same plane parallel to the upper surface 113.

Two holes 118 are respectively formed on the bottom surfaces of the first and second cavities 116, 117 and penetrating the lower surface 115 of the basic body 112 for respectively mounting the two lamps 130 inside the first and second cavities 116, 117. The first cavity 116 and the second cavity 117 cooperating with the basic body 133, respectively construct a high illumination light cover 111 and a low illumination light cover 119. A curvature at any point on the bottom surface of the first cavity 116 is larger than a curvature at the corresponding point of the second cavity 117. That is, a diameter of the first cavity 116 is smaller than a diameter of the second cavity 117. As a result, the emitting angle of light beams reflected by the bottom of the first cavity 116 is smaller than the emitting angle of the light beams reflected by the bottom of the second cavity 117.

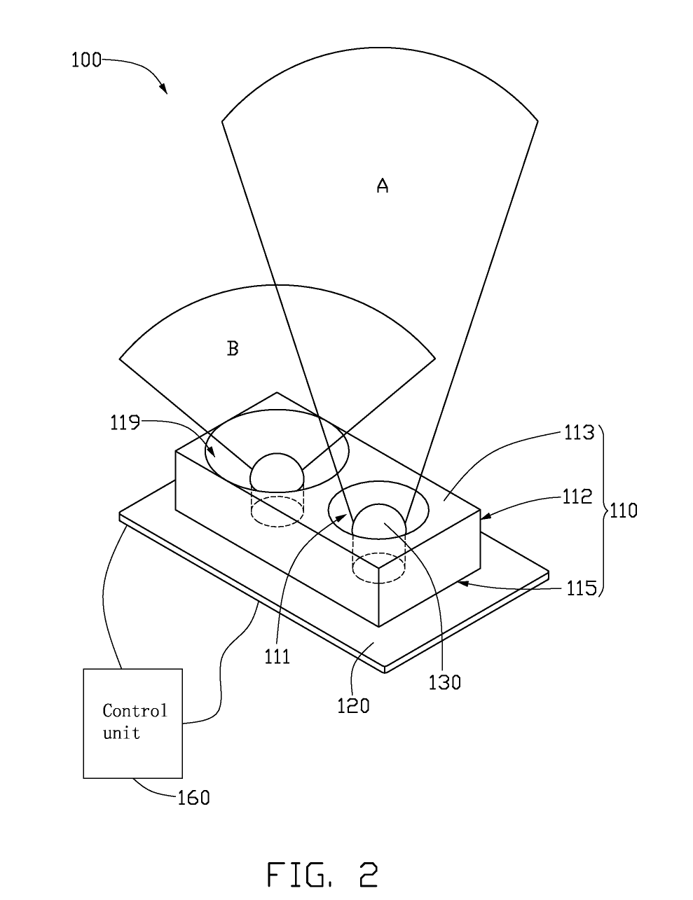

Referring to FIG. 2, depending on the shapes of the first cavity 116 and the second cavity 117, light beams A reflected by the first cavity 116 are relatively focused distantly and the illumination scope thereof is relatively far which is adapted to act as an auxiliary high light for illuminating a far object or scene for assistance in capturing far images. Light beams B reflected by the second cavity 117 are relatively focused closely and the illumination scope thereof is relatively short as low illumination light for illuminating a nearby object or scene for assistance in capturing close images.

Alternatively, on the bottoms of the first and second cavities 116, 117 may be coated with a reflecting film, coating or other reflective material to improve the efficiency of light reflection and to improve the luminance of the light reflected by the high illumination light cover 111 or the low illumination light cover 119 for different illumination scopes.

The circuit board 120 is used for providing an electrical path to the lamps 130. The circuit board 120 supports the lamp cover 110 thereon and is electrically connected to a control unit 160, which is used for supplying electrical power to the lamps 130.

The lamps 130 are preferably light-emitting diodes (LED), and are respectively disposed inside the first and second cavities 116 and 117 via the holes 118. One end of each lamp 130 protrudes from the lowest points of the bottoms of the first cavity 116 and the second cavity 117 at a predetermined distance, and the other end of each lamp 130 is electrically connected to the circuit board 120. When the lamps 130 are lighting, a part of the light beams directly emit outside the lamp cover 110, and the rest of the light beams are reflected by the lamp cover 110. Therefore, intensity of the emitting light beams is improved.

Alternatively, the auxiliary illumination device 100 may be divided into two separate portions respectively located at different positions of a device using auxiliary light. One portion for providing auxiliary high illumination light includes the high illumination light cover 111, and the lamp 130. The other portion for providing auxiliary low illumination light includes the low illumination light cover 119, and the lamp 130. Therefore, the auxiliary illumination device 100 can meet the requirement of respectively mounting the auxiliary high illumination light component and the auxiliary low illumination light component at different positions of a camera or the like.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An auxiliary illumination device comprising:
a circuit board;
a lamp cover comprising: a high illumination light cover mounted on the circuit board;
and a low illumination light cover mounted on the circuit board; and at least two lamps electrically connected to the circuit board and disposed inside the high illumination light cover and the low illumination light cover respectively.

2. The auxiliary illumination device as claimed in claim 1, wherein the lamp cover comprises a basic body comprising an upper surface and a lower surface opposite to the upper surface, a first cavity and a second cavity are adjacently spaced apart on the upper surface of the basic to form the high illumination light cover and the low illumination light cover on the basic body, and a diameter of the first cavity on the upper surface is smaller than a diameter of the second cavity.

3. The auxiliary illumination device as claimed in claim 2, wherein bottoms surface of the first cavity and the second cavity are concave surface.

4. The auxiliary illumination device as claimed in claim 2, wherein a shape of bottoms of the first cavity and the second cavity is selected from the group of a spherical surface and an aspherical surface.

5. The auxiliary illumination device as claimed in claim 2, wherein a curvature of a bottom of the first cavity is larger than a curvature of a bottom of the second cavity.

6. The auxiliary illumination device as claimed in claim 2, wherein two holes are respectively formed on bottoms of the first cavity and the second cavity and penetrating the lower surface of the basic body for respectively mounting the lamps in the first cavity and the second cavity.

7. The auxiliary illumination device as claimed in claim 2, wherein bottoms of the first cavity and the second cavity are coated by material selected from the group of a reflecting film, coating and reflecting materials.

8. The auxiliary illumination device as claimed in claim 2, wherein lowest points of bottoms of the first cavity and the second cavity are located on a same plane paralleled with the upper face of the basic body.

9. The auxiliary illumination device as claimed in claim 1, wherein the lamp cover comprises a divided basic body having an upper surface and a lower surface opposite to the upper surface, a first cavity and a second cavity are respectively spaced apart on the upper surface of the basic to form the high illumination light cover and the low illumination light cover on the basic body, a diameter of the first cavity on the upper face is smaller than a diameter of the second cavity, and the high illumination light cover and the low illumination light cover are separated from each other.

10. The auxiliary illumination device as claimed in claim 9, wherein bottoms of the first cavity and the second cavity are concave surfaces.

11. The auxiliary illumination device as claimed in claim 9, wherein a shape of bottoms of the first cavity and the second cavity are selected from the group of a spherical surface and an aspherical surface.

12. The auxiliary illumination device as claimed in claim 9, wherein a curvature of a bottom of the first cavity is larger than of a curvature of a bottom of the second cavity.

13. The auxiliary illumination device as claimed in claim 9, wherein two holes are respectively formed on bottoms of the first cavity and the second cavity and penetrating the lower surface of the basic body for mounting the lamps in the first cavity and the second cavity.

14. The auxiliary illumination device as claimed in claim 9, wherein bottoms of the first cavity and the second cavity are coated by material selected from the group of a reflecting film, coating and reflecting materials.

15. The auxiliary illumination device as claimed in claim 9, further comprising a control unit electrically connected to the circuit board for supplying power to one of the lamp disposed inside the high illumination light cover and the lamp disposed inside the low illumination light cover.

16. The auxiliary illumination device as claimed in claim 9, wherein lowest points of bottoms of the first cavity and the second cavity are located on a same plane paralleled with the upper face of the basic body.
